(19) United States
(12) Patent Application Publication
(10) Pub. No.: US 2005/0225160 A1
(43) Pub. Date: Oct. 13, 2005

(54) Wheel shield

(76) Inventor: Vaughn V. Barnes, Corona Del Mar, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 10/524,324

(22) PCT Filed: Aug. 20, 2003
(86) PCT No.: PCT/US03/26137

§ 371 Date: Feb. 10, 2005

Related U.S. Application Data
(60) Provisional application No. 60/404,835, filed on Aug. 20, 2002.
(60) Provisional application No. 60/439,911, filed on Jan. 13, 2003.

(51) Int. Cl. B60B 7/00

(52) U.S. Cl. 301/37.101

(57) ABSTRACT

A wheel shield adapted to protect a wheel from materials such as brake dust, and in so doing modify the appearance of a wheel and/or modify the flow of air across an outboard surface of the wheel. Also disclosed are a method of mounting a wheel shield to a vehicle, as well as features that improve the shields ability to dissipate heat, and which improve visibility of the shield while decreasing the amount of glare produced by the shield.

This application claims the benefit of U.S. provisional application Nos. 60/404,835 (filed Aug. 20, 2002) and 60/439,911 (filed Jan. 13, 2003), each of which is incorporated herein by reference in its entirety.

### FIELD OF THE INVENTION

The field of the invention is automobile wheels.

### BACKGROUND OF THE INVENTION

Vehicle wheels generally comprise a rim, and a center section that bolts to the vehicle's brake drum or rotor. The center section is typically referred to as a disc or spider, but the term “spider” will be used herein. When mounted on a vehicle, the rim supports a tire, and the spider connects the rim and tire to the vehicle. Wheels can be made of any suitably strong and durable material, including steel, aluminum, magnesium, titanium, and even composite materials.

Wheel shields are shield plates/dust covers that form a barrier between the outboard surface of a wheel and the brake drum or rotor adjacent to the wheel. Examples of wheel shields can be found in various U.S. patents such as U.S. Pat. Nos. 5,722,734 and 6,047,796, as well as 6,155,650, 4,484,667, and 4,005,768.

Although known wheel shields can be presumed to provide some benefits in some circumstances, it is contemplated that improved wheel shields may provide additional benefits.

### SUMMARY OF THE INVENTION

The present invention is directed to a wheel shield adapted to protect a wheel from materials such as brake dust, and in so doing modify the appearance of a wheel and/or modify the flow of air across an outboard surface of the wheel. The present invention is also directed to a novel method of mounting a wheel shield to a vehicle, as well as features that improve the shields ability to dissipate heat, and which improve visibility of the shield while decreasing the amount of glare produced by the shield.

Preferred wheel shields are adapted to be secured to a wheel's inboard surface, the inboard surface being defined by a wheel disk or spider and a rim flange circumscribing the spider on each side of the wheel. As used herein, the outboard surface of a wheel is that surface of the wheel that would be visible to an observer viewing a vehicle to which the wheel was mounted. Similarly, the inboard surface of a wheel is that surface of the wheel which would normally not be visible to such an observer, and which normally faces the vehicle rather than facing away from the vehicle.

Preferred wheel shields have an outboard surface that sufficiently conforms to an inboard surface of a wheel such that the shield, when coupled to the wheel, closes any openings in the disk or spider of the wheel, preferably by engaging the inboard sides of the wheel at points immediately surrounding such openings.

Preferred wheel shields also have a textured outboard surface such that portions of the shield visible through any openings in a wheel disk or spider will not have a flat appearance. Texturing the outboard surface is contemplated to increase visibility of the shield, to reduce unwanted reflections from the shield, to improve heat dissipation characteristics of the shield, and to affect airflow over the shield and wheel. Texturing the surface is also contemplated to cause at least one ventilation opening to be formed between the shield and an adjacent wield to help reduce accumulation of moisture between the wheel and the shield.

Preferred wheel shields are also coupled to a wheel either by clamping a center portion of the shield between a wheel and a hub to which the wheel is mounted or by fastening the shield to the wheel disk or spider.

Contemplated wheel shields can be formed in any manner such as by casting or milling, but are preferably formed by texturing a sheet of material and then using a hydraulic press to shape the sheet so that it conforms to the shape of a wheel.

Contemplated wheel shields can be formed from any material but are preferably formed from 0.10 inch thick doubly corrugated stainless steel, or, less preferably from 0.05 to 0.10 thick or from 0.10 to 0.15 thick doubly corrugated stainless steel.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a view of a first wheel shield embodying the invention.

FIG. 2 is a cutaway side view of a combination embodying the invention of a wheel and the wheel shield of FIG. 1.

FIG. 3 is a view of a second wheel shield embodying the invention.

FIG. 4 is a cutaway side view of a combination embodying the invention of a wheel and the wheel shield of FIG. 3.

FIG. 5 is a view of the outboard surfaces of a combination embodying the invention of a wheel and wheel shield.

FIG. 6 is a perspective view of a sheet of material being fed into a corrugator.

FIG. 7 is a perspective view of the sheet of FIG. 6 leaving the corrugator.

FIG. 8 is a perspective view of the corrugated sheet of FIG. 7.

FIG. 9 is a perspective view of the corrugated sheet of FIG. 7 leaving the corrugator a second time after being rotated ninety degrees.

FIG. 10 is a perspective view of the doubly corrugated sheet of FIG. 9.

FIG. 11 is a perspective view of a wheel shield formed from the sheet of FIG. 10.

FIG. 12 is a perspective view of the wheel shield of FIG. 11 in combination with a wheel that it conforms to.

### DETAILED DESCRIPTION

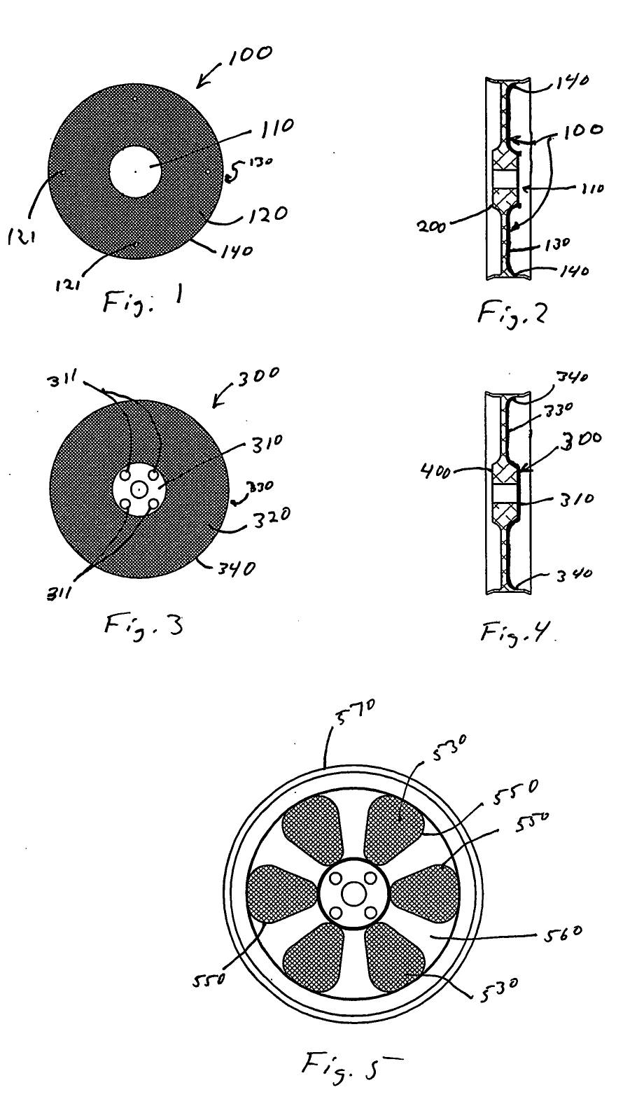

In FIG. 1, a wheel shield 100 comprises a center opening 110, a textured outboard surface 120, an inboard surface 130, and a rim 140. Outboard surface 120 is preferably shaped to conform to the inboard surface of a wheel. Shield 100 also comprises holes 121 for fastening shield 100 to the web of a wheel. As such, shield 100 corresponds to a particular size and type of wheel, said wheel being referred to herein as the “shield's wheel” and the “corresponding wheel”. Rim 140 is preferably circular and preferably has a diameter less than the interior diameter of the rim of the shield's wheel. FIG. 2 illustrates a combination comprising shield 100 and a wheel 200.

It is contemplated that shield 100 may comprise any material or combination of materials and may comprise a single piece or multiple pieces. Similarly, shield 100 can be formed in any manner such as by milling, forging, and/or casting. However, a preferred shield will comprise a single piece of 0.10 inch thick stainless steel hydraulically pressed to form shield 100.

In FIG. 3, a wheel shield 300 comprises a center portion 310, a textured outboard surface 320, an inboard surface 330, and a rim 340. Center portion 310 is adapted to be clamped between two planar surfaces and comprises a shortened cylindrical body having parallel planar ends and holes 311 sized and positioned to allow lug bolts to pass through center portion 310. FIG. 4 illustrates a combination comprising shield 300 and a wheel 400.

For shields such as shield 300 that are adapted to be clamped between a wheel and a hub, it is preferred that the shield be sufficiently rigid that shield 300 not be forced away from the inboard surface of it's wheel during operation of the vehicle. Sufficient rigidity can be obtained by choosing a thickness appropriate to the material used to form the shield.

As can best be seen in FIG. 5 depicting a combination of wheel shield and wheel, preferred wheel shields comprise an outboard surface 530 that is textured to modify the appearance of any wheel it is coupled to by being visible through openings 550 in web 560 of wheel 570. In preferred embodiments the surface will comprise one or more ridges pressed into the surface while forming the shield. It is contemplated that in some embodiments only portions of the surface will be textured with such textured portions being sized and dimensioned to correspond to portions of the shield that would be visible from the outboard side of a wheel the shield was coupled to. It is contemplated that texturing visible portions of the wheel shield provides at least five advantages.

One advantage texturing provides is that filling in openings in a wheel with the textured shield may result in a combination that has a more desirable appearance than the wheel alone would. Another advantage is that the textured surface can scatter light reflected by the shield. As such it will be less likely to create an intense, unwanted glare while simultaneously making reflected light visible in a greater number of directions. A third advantage that texturing provides is that filling holes in a wheel with a textured surface may advantageously modify the air flow over the wheel web.

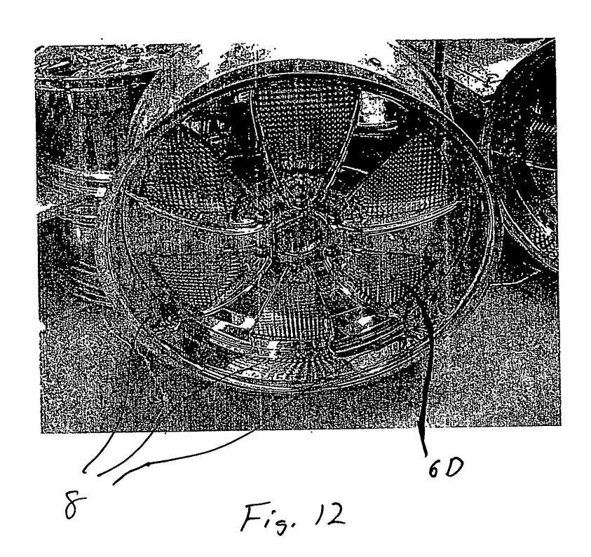

Texturing the surface so as to cause multiple reflections from a single source servers to illuminate significantly more of the surface of a wheel rim than would occur with a non-textured surface. The benefit of this is that the rim appears to be illuminated at night, and to be illuminated with a particular color that changes depending on the current color of the light hitting the wheel shield. Referring to FIG. 12, reflections 8 help illustrate the ability of the textured surface to illuminate multiple portions of the rim.

A fourth advantage is that texturing the exposed outboard surface of the shield improves the shield's heat dissipation characteristics by increasing the amount of surface exposed. It is contemplated that use of the shield tends to reduce air flow through the wheel and over the breaking mechanism with the result that the amount of heat dissipated to such air flow is reduced. The reduction in heat dissipation can be partially compensated for by increasing the dissipation characteristics of the shield which can be directly or indirectly in thermal contact with the breaking mechanism.

A fifth advantage is that texturing generally results in at least one ventilation opening being formed between the shield and the wheel. The solid portions of a web surrounding openings in the web will often have a curved surface such that pressing a shield against the perimeter of the openings will form enclosed cavities. It is contemplated that such cavities can be prone to accumulate and retain moisture to the long term detriment of the wheel. As such, it is preferred that at least one ventilation opening into any cavity formed by combining the wheel and shield be left open. In less preferred embodiments, some cavities may not comprise such ventilation openings.

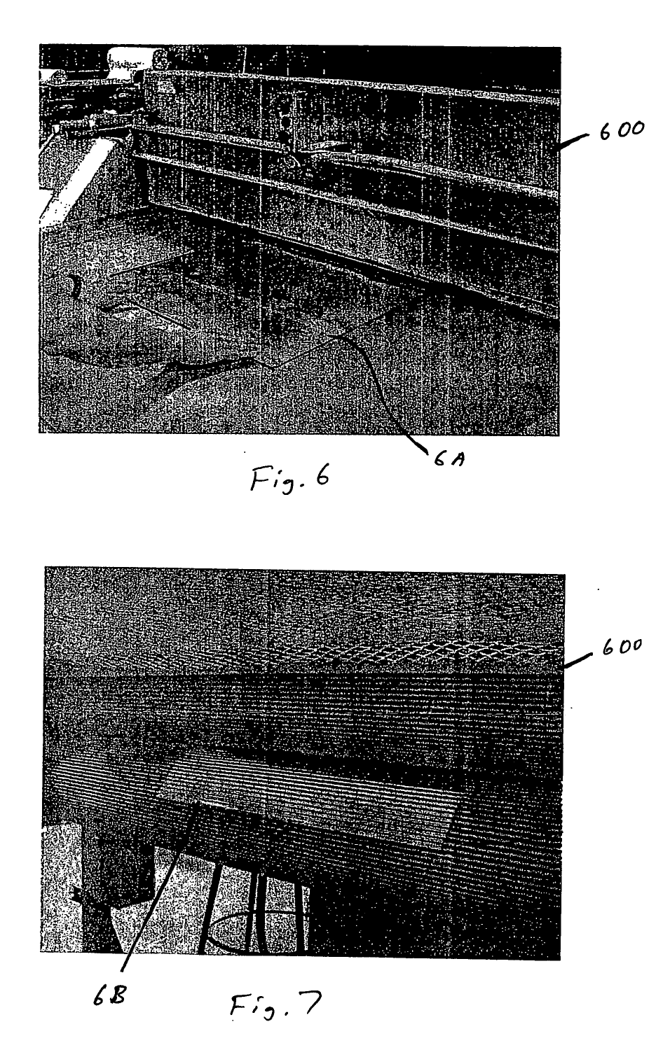

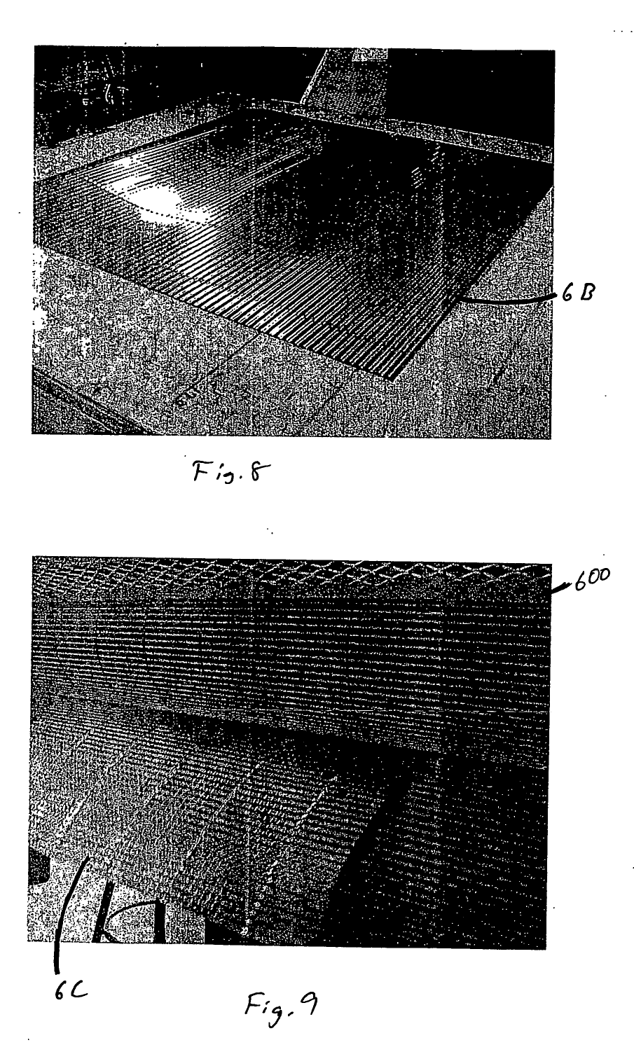

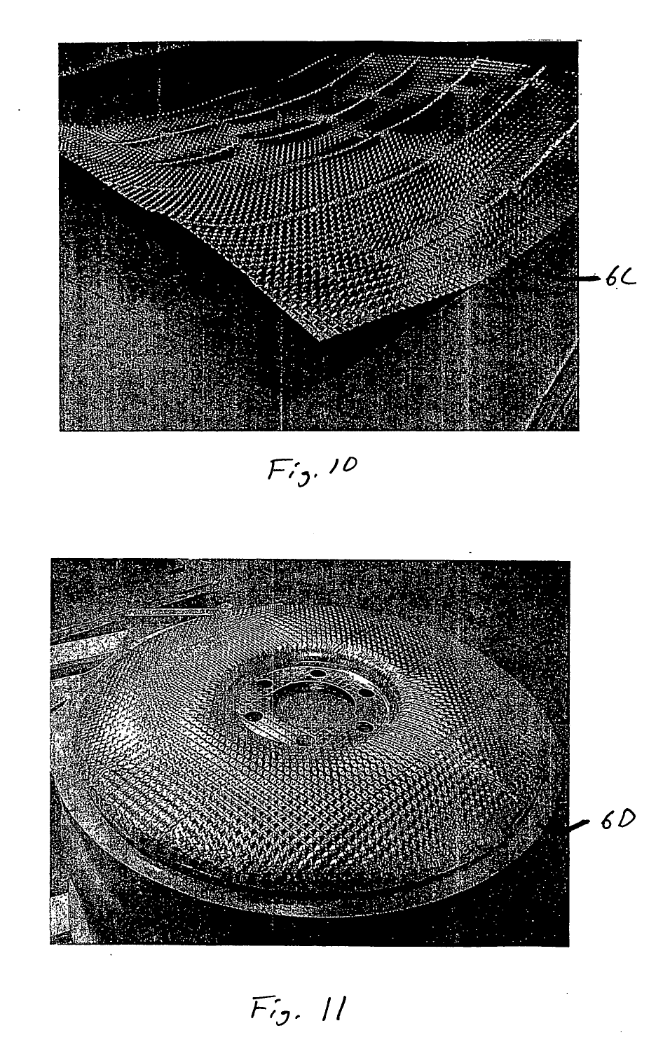

FIGS. 6-12 illustrate a preferred method of forming a wheel shield. In FIG. 6 a square sheet 6A of 0.10 thick stainless steel is fed into a corrugator 600. FIG. 7 shows singly corrugated sheet 6B as it exits the corrugator 600, and FIG. 8 shows the sheet 6B once it has been removed from the corrugator 600. After being removed from corrugator 600, singly corrugated sheet 6B is rotated ninety degrees and run through the corrugator again to form a doubly corrugated sheet 6C. FIG. 9 shows doubly corrugated sheet 6C as it exits the corrugator 600, and FIG. 10 shows the sheet 6C once it has been removed from the corrugator 600. FIG. 11 shows a wheel shield 6D formed from sheet 6C by hydraulically pressing sheet 6C into a shape that at least partially conforms to the interior shape of a particular wheel, drilling any necessary holes, and otherwise finishing the shield. FIG. 12 shows shield 6D fitted into the wheel its shape corresponds to with the combination being ready for mounting to a vehicle.

Although the preferred texture of the outboard surface is formed by doubly corrugating a sheet of stainless steel, other patterns and other forming methods can also be used to form less preferred embodiments. As such, in some instances a sheet may only be singly corrugated prior to use or can be textured by milling, etching, pressing, or some other method. Similarly, in some instances the texture can be a brush or satin finish where variations in the textured surface are dense yet slight.

Although the process used results in the entire outboard surface of the wheel shield being textured, it is contemplated that some embodiments may only texture exposed portions of the shield. Similarly, although both the inboard and outboard surfaces of the shield are textured in the preferred embodiment, the use of alternative methods may result in a shield that is only textured on its outboard surface.

Although the corrugations formed are preferred to be 50-60 thousands of an inch deep, alternative embodiments and/or methods may utilize deeper or shallower corrugations.

Thus, specific embodiments and applications of wheel shields have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced.

1. A wheel shield comprising a curved and textured outboard surface adapted to conform to an inboard surface of a wheel.

2. The wheel shield of claim 1, wherein the outboard surface comprises a plurality ridges.

3. The wheel shield of claim 1, wherein the shield comprises a center opening adapted to prevent the shield from being sandwiched between a wheel and a hub when mounted to a vehicle.

4. The wheel shield of claim 3, wherein the shield comprises a plurality of holes positioned to be adjacent to the web of a wheel when the shield is mounted to a vehicle such that it is adjacent to the wheel.

5. The wheel shield of claim 1, wherein the shield comprises a plurality of holes positioned to be adjacent to the web of a wheel when the shield is mounted to a vehicle such that it is adjacent to the wheel.

6. A combination of a wheel and wheel shield according to claim 5, wherein the wheel shield is fastened directly to the wheel by bolts or screws passing through the plurality of holes and into the web of the wheel.

7. A combination of a wheel and wheel shield according to claim 1, wherein the wheel comprises a web having a plurality of holes passing through it, the web is curved between the holes, and the wheel shield is positioned adjacent to the wheel such that the holes in the web are blocked by the shield and the shield and the solid portion of the web form at least one cavity, the combination comprising at least one ventilation opening formed by the wheel and wheel shield between the cavity and an opening in the web.

8. A method of forming the wheel shield of claim 1, comprising using a hydraulic press to cause a sheet of doubly corrugated material to conform to the shape of an inboard surface of a wheel.
